(19) United States
(12) Patent Application Publication
(10) Pub. No.: US 2012/0310621 A1
(43) Pub. Date: Dec. 6, 2012

(54) PROCESSOR, DATA PROCESSING METHOD THEREOF, AND MEMORY SYSTEM INCLUDING THE PROCESSOR

(76) Inventors: SEH WOONG JEONG, Seoul (KR); Jae Sop Kong, Seoul (KR)

(21) Appl. No.: 13/474,942

(22) Filed: May 18, 2012

(30) Foreign Application Priority Data
May 30, 2011 (KR) 10-2011-0051253

(51) Int. Cl. G06F 9/455; G06F 12/00

(52) U.S. Cl. 703/23; 711/154; 711/E12.001

(57) ABSTRACT

A processor includes an emulator configured to receive an access command from a second memory controller, and a first memory controller configured to control an operation of a memory. The emulator is configured to determine whether the first memory controller is available to perform an operation corresponding to the access command, and transmit a wait signal to the second memory controller upon determining that the first memory controller is not available to perform the operation.

### CROSS-REFERENCE TO RELATED APPLICATION

This application claims priority under 35 U.S.C. §119 to Korean Patent Application No. 10-2011-0051253 filed on May 30, 2011, the disclosure of which is herein incorporated by reference in its entirety.

### TECHNICAL FIELD

The present invention relates to a memory system, and more particularly, to a processor capable of managing variable access latency in a memory system, a data processing method thereof, and a memory system including the processor.

### DISCUSSION OF THE RELATED ART

In memory systems including a plurality of processors operating in connection with a dynamic random access memory (DRAM), while one of the processors is accessing the DRAM in response to an access command, the DRAM is not available to be accessed by the other processors.

In such a memory system, when RAS/CAS latency is set to be large even though the access latency of one of the processors is variable, system performance may deteriorate. A packet method may be used to connect the plurality of processors and avoid the deterioration of system performance. Such packet methods utilize logic in addition to an existing DRAM controller in the processors.

### SUMMARY

Exemplary embodiments of the present invention include a processor capable of managing variable access latency, a data processing method thereof, and a memory system including the processor.

According to an exemplary embodiment of the present invention, a processor includes an emulator configured to receive an access command from a second memory controller, and a first memory controller configured to control an operation of a memory. The emulator is configured to determine whether the first memory controller is available to perform an operation corresponding to the access command, and transmit a wait signal to the second memory controller upon determining that the first memory controller is not available to perform the operation corresponding to the access command.

The emulator may include a memory interface operatively coupled to the second memory controller and configured to receive the access command, and an emulator controller configured to transmit the wait signal to the second memory controller via the memory interface.

The emulator may include a cache memory configured to store read data received from the memory and write data to be written to the memory, and a cache controller configured to control an operation of the cache memory.

The emulator may include a prefetch buffer configured to store read data received from the memory, or a write buffer configured to store write data to be written to the memory. The access command may include priority information, and the emulator may receive the priority information, analyze the priority information, and control a first memory controller to perform an operation corresponding to the access command according to an analysis result. The priority information may include a chip selection signal or an address signal.

According to an exemplary embodiment of the present invention, a memory system includes a memory and a second processor including a second memory controller which accesses the memory via a first processor. The first processor includes an emulator configured to receive an access command from the second memory controller, and a first memory controller configured to control an operation of the memory. The emulator is configured to determine whether the first memory controller is available to perform an operation corresponding to the access command, and transmit a wait signal to the second memory controller upon determining that the first memory controller is not available to perform the operation corresponding to the access command.

The emulator may include a memory interface operatively coupled to the second memory controller and configured to receive the access command, and an emulator controller configured to transmit the wait signal to the second memory controller via the memory interface.

The emulator may control a cache memory configured to store read data received from the memory and write data to be written to the memory, and a cache controller configured to control an operation of the cache memory.

The emulator may include a prefetch buffer configured to store read data received from the memory. The emulator may include a write buffer configured to store write data to be written to the memory. The second processor may include a plurality of intellectual property (IP) blocks and an interconnector, and the IP blocks may be operatively coupled to the second memory controller through the interconnector.

According to an exemplary embodiment of the present invention, a data processing method includes receiving an access command from a second memory controller disposed in a second processor, determining whether a first memory controller in a first processor is available to perform an operation corresponding to the access command, generating a wait signal upon determining that the first memory controller is not available to perform the operation, transmitting the wait signal to the second memory controller, and performing the operation upon determining that the first memory controller is available to perform the operation.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram of a memory system according to an exemplary embodiment of the present invention;

FIGS. 2A through 2D are block diagrams of an emulator illustrated in FIG. 1, according to exemplary embodiments of the present invention;

FIG. 3 is a flowchart showing a method of reading data in the memory system illustrated in FIG. 1, according to an exemplary embodiment of the present invention;

FIG. 4 is a flowchart showing a method of writing data in the memory system illustrated in FIG. 1, according to an exemplary embodiment of the present invention;

FIG. 5 is a timing chart corresponding to the read operation of the memory system illustrated in FIG. 1, according to an exemplary embodiment of the present invention;

FIG. 6 is a timing chart corresponding to the write operation of the memory system illustrated in FIG. 1, according to an exemplary embodiment of the present invention;

FIG. 7 is a flowchart showing a method of reading data in the memory system illustrated in FIG. 1, according to an exemplary embodiment of the present invention; and

FIG. 8 is a flowchart showing a method of writing data in the memory system illustrated in FIG. 1, according to an exemplary embodiment of the present invention.

### DETAILED DESCRIPTION

Exemplary embodiments of the present invention will be described more fully hereinafter with reference to the accompanying drawings. Like reference numerals may refer to like elements throughout the accompanying drawings.

It will be understood that when an element is referred to as being “operatively coupled” to another element, it can be directly connected or coupled to the other element or intervening elements may be present.

It will be understood that, although the terms first, second, etc. may be used herein to describe various elements, these elements should not be limited by these terms. These terms are only used to distinguish one element from another. For example, a first processor could be termed a second processor, and, similarly, a second processor could be termed a first processor without departing from the teachings of the disclosure.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, operations, elements, and/or components, but do not preclude the presence or addition of one or more other features, operations, elements, components, and/or groups thereof.

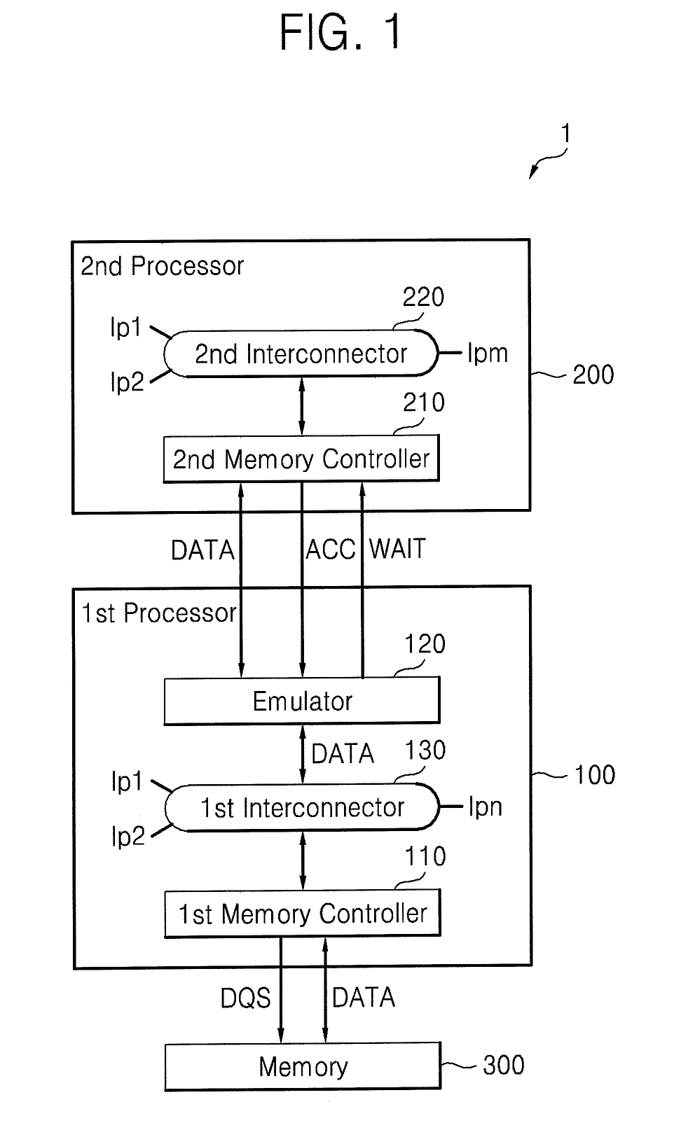

FIG. 1 is a block diagram of a memory system 1 according to an exemplary embodiment of the present invention. The memory system 1 includes a first processor 100, a second processor 200, and a memory 300 operatively coupled to the first processor 100.

The first processor 100 may include a first memory controller 110 and an emulator 120. The first processor 100 may also include a first interconnector 130 and a plurality of intellectual property (IP) blocks IP1, IP2, . . . , IPn. IP modules or IP cores may also be utilized, and the IP blocks, IP modules, or IP cores may perform predetermined functions. The first memory controller 110, the emulator 120, and the IP blocks IP1 through IPn may be operatively coupled to one another via the first interconnector 130.

The first memory controller 110 controls the operation of the first processor 100. The first memory controller 110 is operatively coupled to the memory 300 and writes and reads data DATA to and from the memory 300.

The emulator 120 is operatively coupled to a second memory controller 210 included in the second processor 200, and transmits and receives data DATA to and from the second processor 200. Upon receiving an access command ACC from the second memory controller 210, the emulator 120 checks the first memory controller 110 to determine whether the first memory controller 110 is available to perform an operation corresponding to the access command ACC (e.g., a write operation or a read operation), and generates and sends a wait signal WAIT to the second memory controller 210 when the first memory controller 110 is not available to execute the access command ACC.

The emulator 120 may receive an access command ACC including priority information, analyze the priority information, and request that the first memory controller 110 performs an operation corresponding to the access command ACC based on the results of the analysis. The priority information may include, for example, a chip selection signal or an address signal.

The second processor 200 may include the second memory controller 210, a second interconnector 220, and a plurality of IP blocks IP1, IP2, . . . , IPm. IP modules or IP cores may also be utilized, and the IP blocks, IP modules, or IP cores may perform predetermined functions. The IP blocks IP1 through IPm may be operatively coupled to the second memory controller 210 via the second interconnector 220. The second memory controller 210 controls the operation of the second processor 200. The second memory controller 210 is operatively coupled to the emulator 120 of the first processor 100 and transmits the access command ACC to the emulator 120. In addition, the second memory controller 210 receives the wait signal WAIT from the emulator 120.

The memory 300 stores data DATA. The memory 300 is operatively coupled to the first memory controller 110 of the first processor 100, and data DATA is read from or written to the memory 300 under the control of the first memory controller 110.

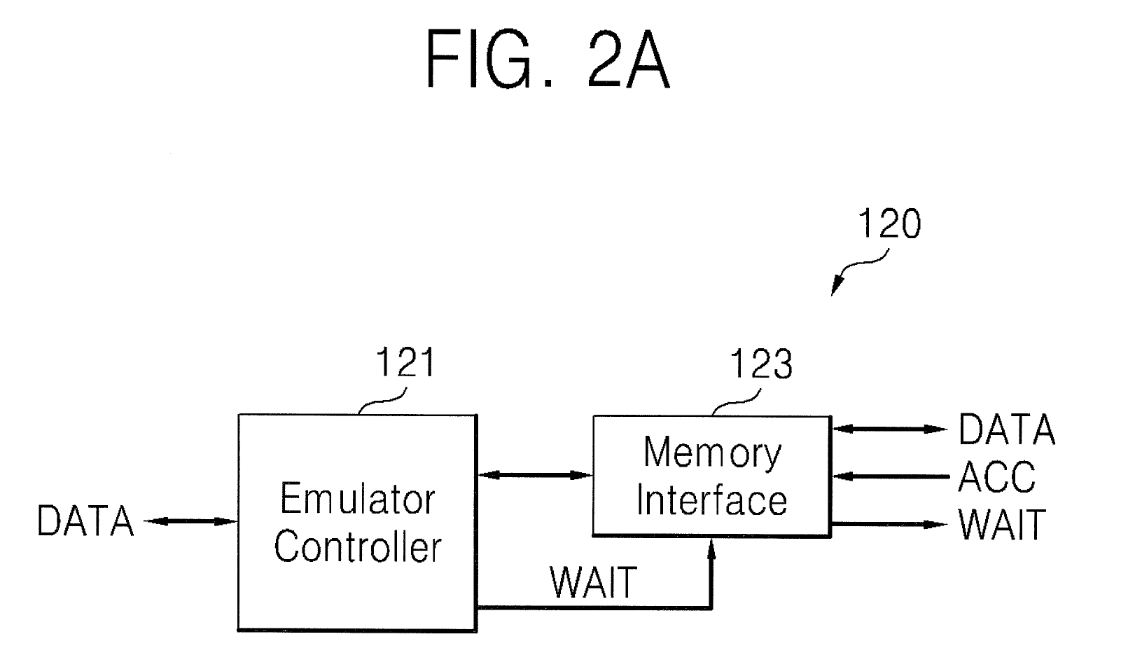

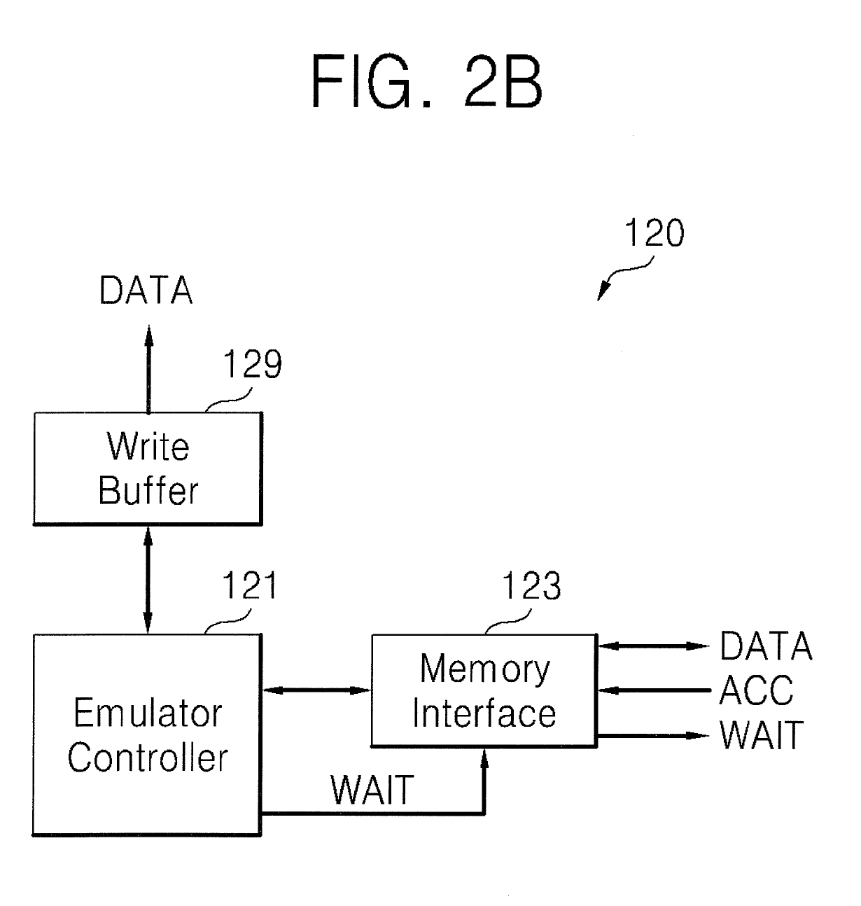

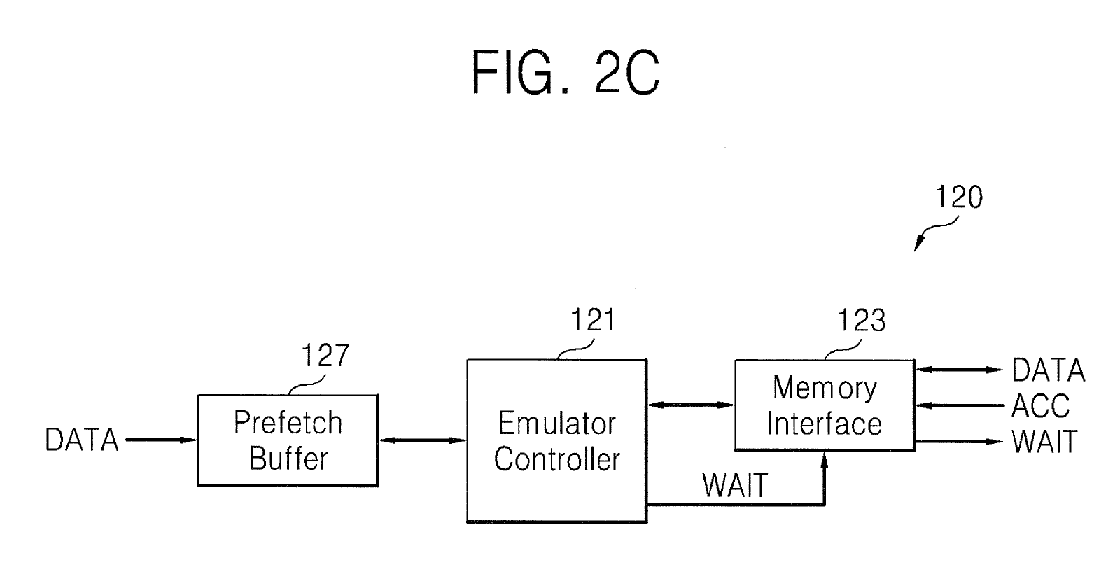

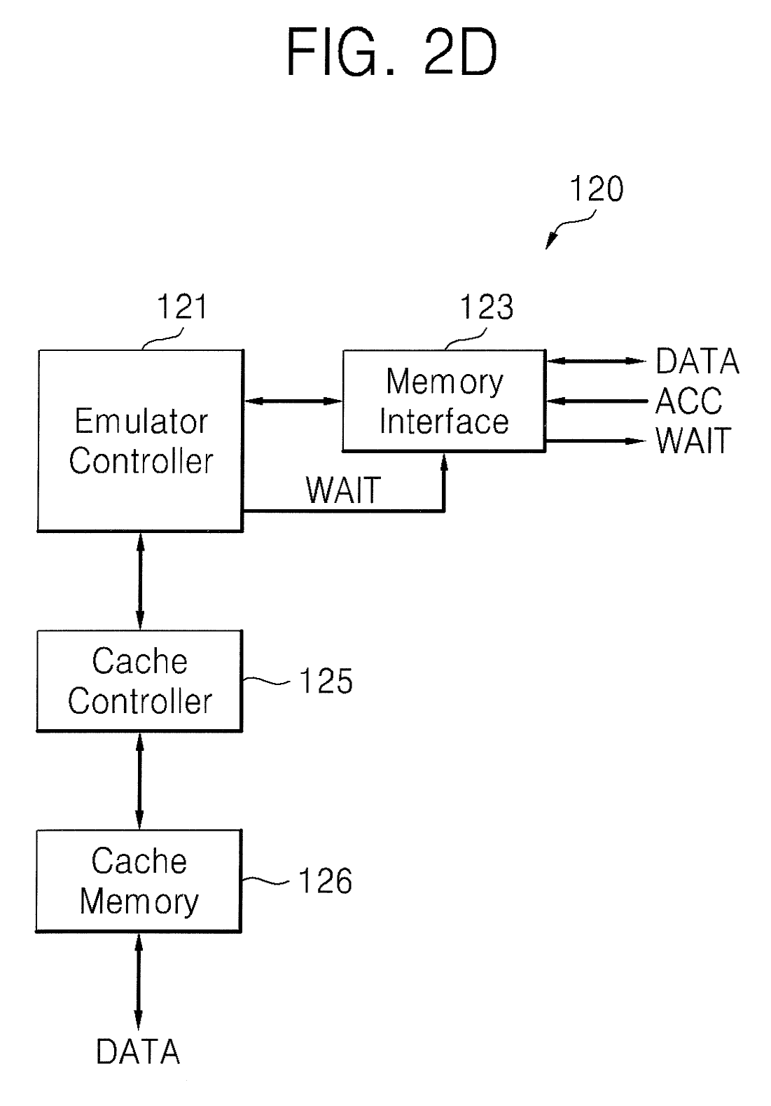

FIGS. 2A through 2D are block diagrams of the emulator 120 illustrated in FIG. 1, according to exemplary embodiments of the present invention. The emulator 120 may include, for example, a memory interface 123 and an emulator controller 121 as shown in FIG. 2A.

The memory interface 123 is operatively coupled to the second memory controller 210 and receives the access command ACC.

The emulator controller 121 controls the operation of the emulator 120. The emulator controller 121 receives the access command ACC from the second memory controller 210 via the memory interface 123.

When receiving a read command, the emulator controller 121 makes a request to the first memory controller 110 for read data corresponding to the read command. The read command includes a reference to memory locations in the memory 300. When receiving a write command, the emulator controller 121 transmits the write command to the first memory controller 110 and makes a request to the first memory controller 110 to write data corresponding to the write command to the memory 300.

When receiving the access command ACC from the second memory controller 210, the emulator controller 121 determines whether the first memory controller 110 is available to perform an operation corresponding to the access command ACC.

When it is determined that the first memory controller 110 is not available to perform the operation corresponding to the access command ACC, the emulator controller 121 generates the wait signal WAIT and transmits the wait signal WAIT to the second memory controller 210 via the memory interface 123. The emulator controller 121 may receive a write command from the second memory controller 210 that initiates writing data to the memory 200, or a read command from the second memory controller 210 that initiates reading data from the memory 300.

When the first memory controller 110 is currently performing a write operation (e.g., a first write operation) or a read operation (e.g., a first read operation), the first memory controller 110 is not available to perform another write operation (e.g., a second write operation) corresponding to the write command (e.g., a second write command) or another read operation (e.g., a second read operation) corresponding to the read command (e.g., a second read command). When the first memory controller 110 is not available to perform the second write or read operation, the emulator controller 121 generates and transmits the wait signal WAIT to the second memory controller 210. The wait signal WAIT informs the second memory controller 210 that the operation corresponding to the second write command or the second read command has not yet been performed.

In an exemplary embodiment, the emulator 120 may include a write buffer 129 that stores write data (e.g., second write data) that may be written to the memory 300, as shown in FIG. 2B. In an exemplary embodiment, the emulator 120 may include a prefetch buffer 127 that stores read data (e.g., second read data) received from the memory 300, as shown in FIG. 2C.

In an exemplary embodiment, the emulator 120 may include a cache controller 125 and a cache memory 126, as shown in FIG. 2D. The cache memory 126 is controlled by the cache controller 125, and may store the second read data received from the memory 300 or the second write data that may be written to the memory 300.

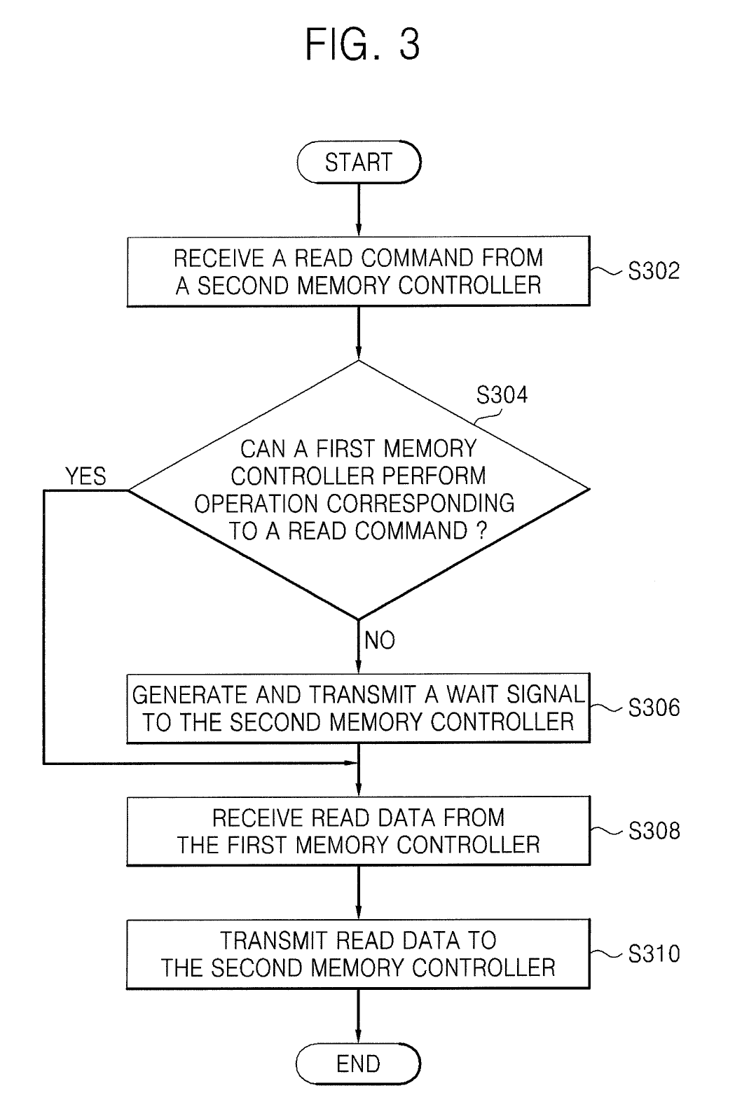

FIG. 3 is a flowchart showing a method of reading data in the memory system 1 illustrated in FIG. 1, according to an exemplary embodiment of the present invention. In the example described below with reference to FIGS. 1 through 3, the emulator 120 of the first processor 100 receives a second read command from the second memory controller 210 of the second processor 200 in operation S302.

The second memory controller 210 and the emulator 120 are operatively coupled to each other via the memory interface 123, and communicate data DATA with each other. Upon receiving the second read command, the emulator controller 121 checks the first memory controller 110 to determine whether the first memory controller 110 is available to perform a second read operation corresponding to the second read command in operation S304.

The emulator controller 121 may make a request to the first memory controller 110 to read data from the memory 300 by transmitting the second read command to the first memory controller 110.

When the first memory controller 110 is not available to perform the second read operation corresponding to the second read command received from the emulator 120 (e.g., when the first memory controller 110 is performing an access operation such as a first read operation or a first write operation on the memory 300), the first memory controller 110 may inform the emulator controller 121 that it is not currently available to perform the second read operation.

When the first memory controller 110 is available to read second read data corresponding to the second read command received from the emulator 120 in operation S304, the emulator controller 121 receives the second read data from the first memory controller 110 in operation S308. The emulator controller 121 then transmits the second read data to the second memory controller 210 via the memory interface 123 in operation S310.

When the first memory controller 110 is not available to read the second read data in operation S304, the emulator 120 generates and transmits a wait signal WAIT to the second memory controller 210 in operation S306. The emulator 120 may continuously generate and transmit the wait signal WAIT to the second memory controller 210 until the first memory controller 110 informs the emulator controller 121 that it is available to read the second read data from the memory 300.

When the first memory controller 110 becomes available to read the second read data from the memory 300, the first memory controller 110 reads the second read data and transmits it to the emulator 120. The emulator 120 receives the second read data from the first memory controller 110 in operation S308, and transmits the second read data to the second memory controller 210 in operation S310.

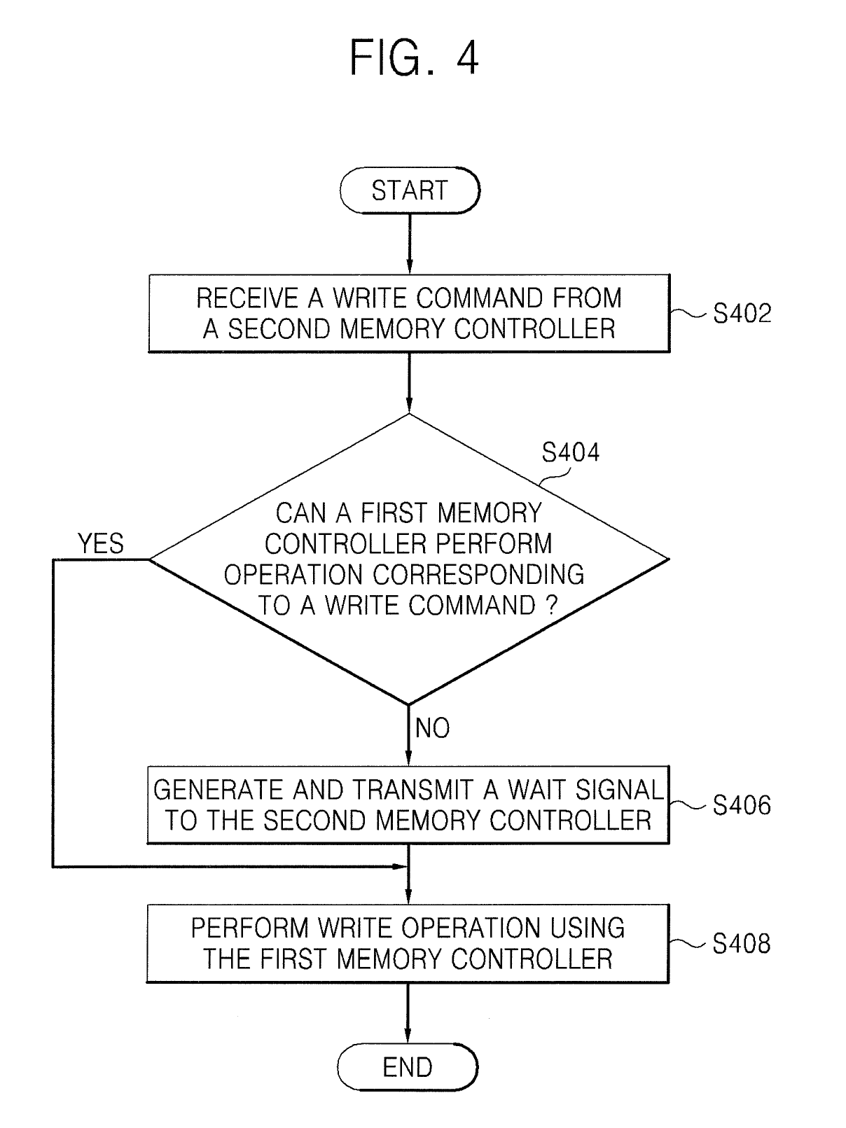

FIG. 4 is a flowchart showing a method of writing data in the memory system 1 illustrated in FIG. 1, according to an exemplary embodiment of the present invention. In the example described with reference to FIGS. 1 through 2D and FIG. 4, the emulator 120 of the first processor 100 receives a second write command from the second memory controller 210 of the second processor 200 in operation S402. Upon receiving the second write command, the emulator controller 121 checks the first memory controller 110 to determine whether the first memory controller 110 is available to write second write data corresponding to the second write command in operation S404.

The emulator controller 121 may make a request to the first memory controller 110 to write the second write data to the memory 300 by transmitting the second write command to the first memory controller 110.

When the first memory controller 110 is not available to perform the second write operation corresponding to the second write command (e.g., when the first memory controller 110 is performing a first read operation or a first write operation), the first memory controller 110 may inform the emulator controller 121 that it is not currently available to perform the second write operation.

When the first memory controller 110 is available to write the second write data in operation S404, the first memory controller 110 performs the second write operation corresponding to the second write command in operation S408. When the first memory controller 110 is not available to write the second write data in operation S404, the emulator 120 generates and transmits a wait signal WAIT to the second memory controller 210 in operation S406. The emulator 120 may continuously generate and transmit the wait signal WAIT to the second memory controller 210 until the first memory controller 110 informs the emulator controller 121 that it is available to write the second write data to the memory 300.

When the first memory controller 110 becomes available to write the second write data to the memory 300, the first memory controller 110 performs the second write operation corresponding to the second write command in operation S408.

In an exemplary embodiment, the methods illustrated in FIGS. 3 and 4 may include receiving an access command ACC including priority information using the emulator 120, analyzing the priority information, and executing the access command ACC based on the results of the analysis. The priority information may include, for example, a chip selection signal or an address signal.

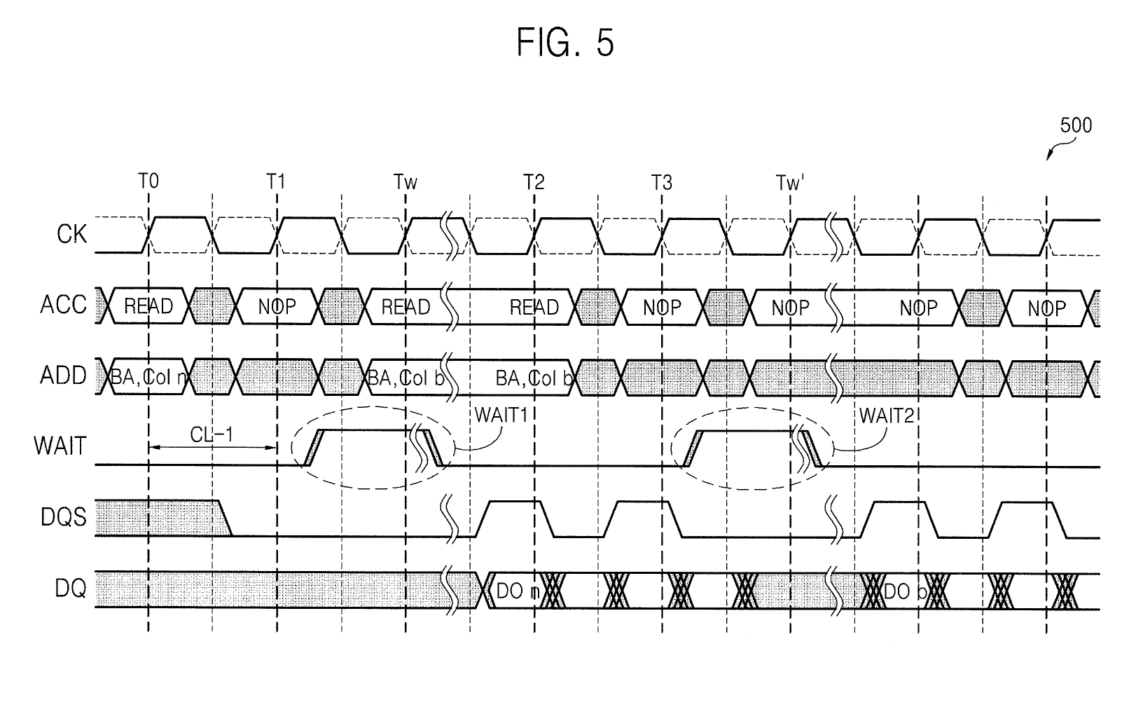

FIG. 5 is a timing chart 500 corresponding to the read operation of the memory system 1 illustrated in FIG. 1, according to an exemplary embodiment. The timing chart 500 includes a clock signal CK, an access command ACC, an address signal ADD, a wait signal WAIT, a data strobe signal DQS, and data DQ. In the example described below with reference to FIG. 5, CAS latency is 2 and the burst length is 4, however the CAS latency and burst length are not limited thereto.

Referring to FIG. 5, the emulator 120 requests the read data from the first memory controller 110 based on an access command ACC (e.g., a read command READ) and the address signal ADD (e.g., BA and Col n, or BA and Col b) received from the second memory controller 210 at time T0 or T2. When the first memory controller 110 is not available to immediately execute the read command READ in response to the clock signal CK at time T1 or T3, the emulator 120 generates and transmits a wait signal WAIT1 or WAIT2 to the second memory controller 210.

When the first memory controller 110 becomes available to execute the read command READ at time Tw or Tw′, the emulator controller 121 stops generating the wait signal WAIT1 or WAIT2, and the first memory controller 110 generates the data strobe signal DQS.

Data DO n or DO b is then output in response to rising and falling edges of the data strobe signal DQS. Generation of the wait signal WAIT1 or WAIT2 may be started before the CAS latency becomes 2 and continued until the read command READ is ready to be executed. For example, generation of the wait signal WAIT1 or WAIT2 may last from time T1 to time Tw, or from time T3 to time Tw′.

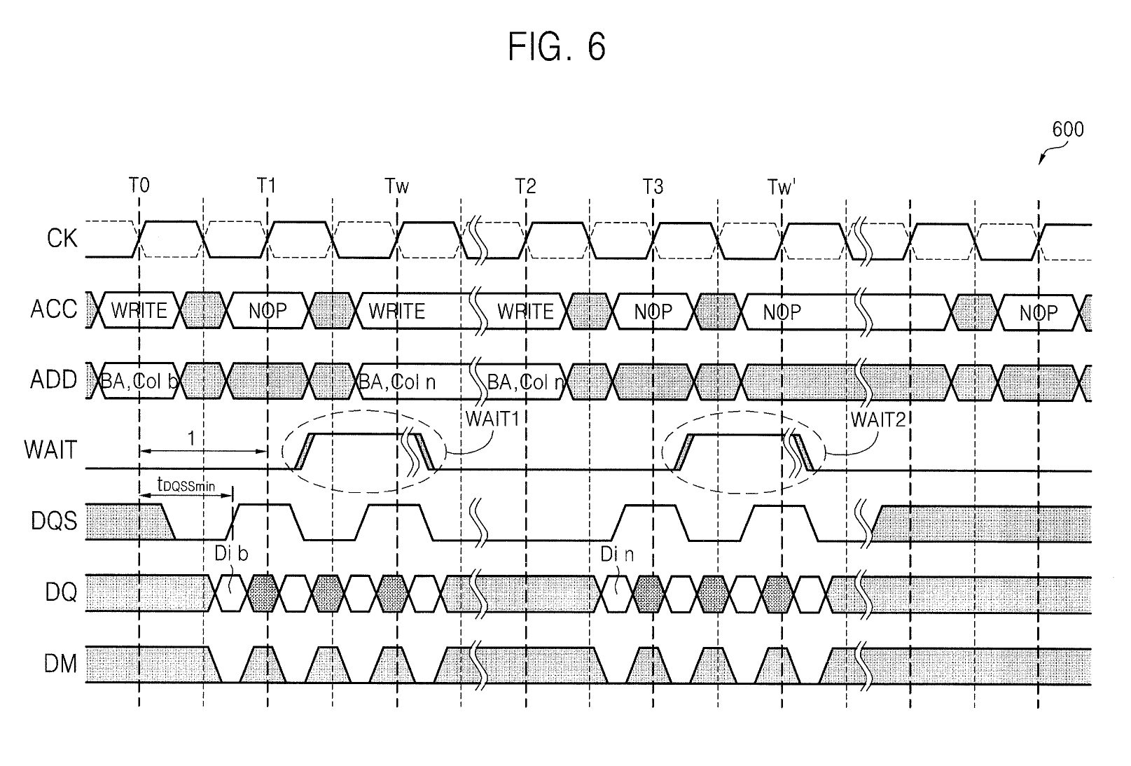

FIG. 6 is a timing chart 600 corresponding to the write operation of the memory system 1 illustrated in FIG. 1, according to an exemplary embodiment. The timing chart 600 includes a clock signal CK, an access command ACC, an address signal ADD, a wait signal WAIT, a data strobe signal DQS, data DQ, and a data mask signal DM. In the example described with reference to FIG. 6, a skew tDQSS (e.g., a relative external interface time between a DQS domain and a clock domain) is about 0.75 tCK and a burst length is 4, however the skew tDQSS and burst length are not limited thereto.

Referring to FIG. 6, the emulator 120 receives a write command WRITE and the address signal ADD from the second memory controller 210 at time T0 or T2, and generates the data strobe signal DQS after the skew tDQSS has elapsed. When the first memory controller 110 is not available to immediately execute the write command WRITE, the emulator 120 generates and transmits a wait signal WAIT1 or WAIT2 to the second memory controller 210.

When the first memory controller 110 becomes available to execute the write command WRITE at time Tw or Tw′, the emulator controller 121 stops generating the wait signal WAIT1 or WAIT2, and the first memory controller 110 generates the data strobe signal DQS. Data Di b or Di n is then written to the memory 300 in response to rising and falling edges of the data strobe signal DQS.

Generation of the wait signal WAIT1 or WAIT2 may be started before the CAS latency becomes 2 and continued until the write command WRITE is ready to be executed. For example, generation of the wait signal WAIT1 or WAIT2 may last from time T1 to time Tw or from time T3 to time Tw′.

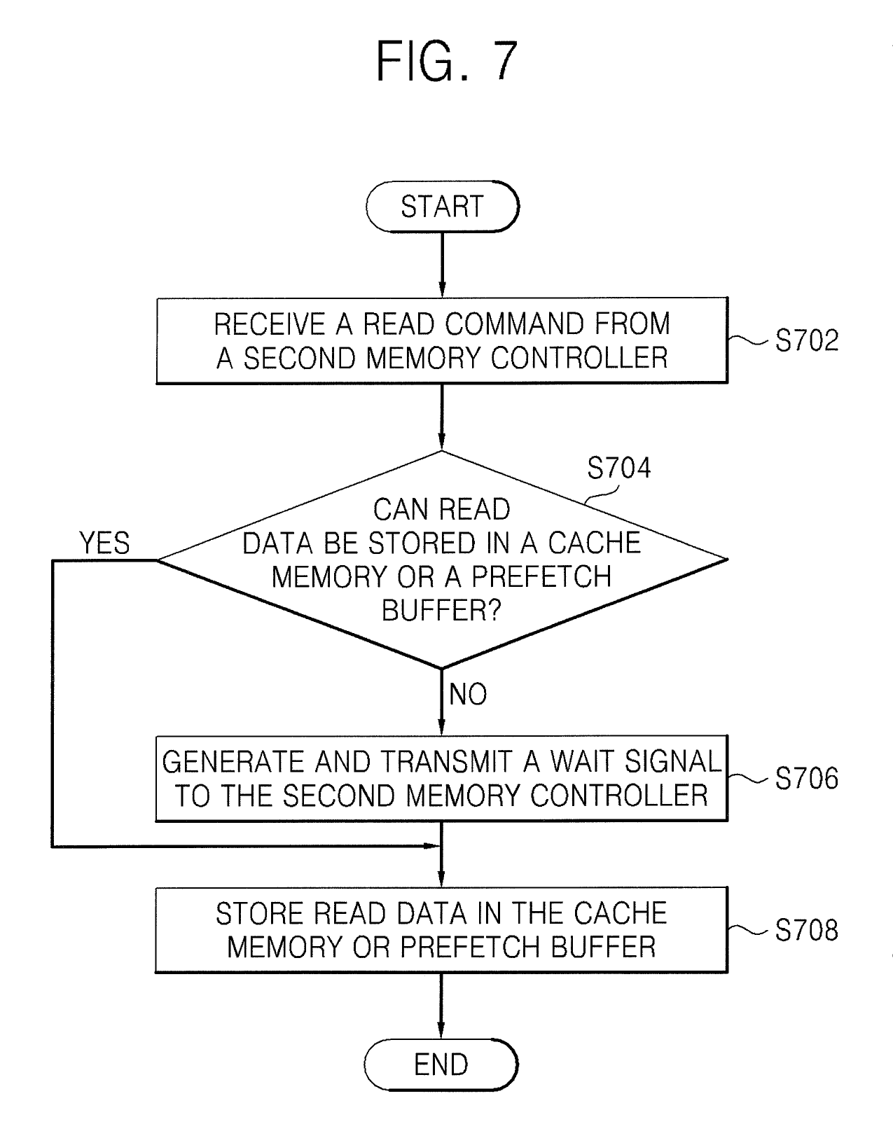

FIG. 7 is a flowchart showing a method of reading data in the memory system 1 illustrated in FIG. 1, according to an exemplary embodiment of the present invention. In the example described below with reference to FIGS. 1 through 2D and FIG. 7, the emulator 120 of the first processor 100 receives a second read command from the second memory controller 210 of the second processor 200 in operation S702. The second memory controller 210 and the emulator 120 are operatively coupled to each other via the memory interface 123 and communicate data DATA with each other.

Upon receiving the second read command, the emulator controller 121 determines whether the cache memory 126 or the prefetch buffer 127 is available to store second read data corresponding to the second read command in operation S704.

The emulator controller 121 may store the second read data in the cache memory 126 or prefetch buffer 127. For example, when the second memory controller 210 requests the second read data to be read from consecutive memory address locations, the emulator controller 121 may receive the second read data from the first memory controller 110 and store it in the cache memory 126 or the prefetch buffer 127 before the second memory controller 210 requests the second read data.

For instance, consider an example where the second memory controller 210 makes a request to the first processor for second read data corresponding to memory address locations 0001, 0010, 0011, 0100, 0101, 0110, in the order of 0001, 0010, 0011, 0100, 0101, 0110, and 0111. When the second memory controller 210 has already requested second read data corresponding to memory address locations 0001 to 0101, the emulator 120 may receive second read data corresponding to subsequent memory address locations (e.g., 0110 to 0111) from the first memory controller 110, and store the second read data in the cache memory 126 or the prefetch buffer 127.

When it is determined that the cache memory 126 or the prefetch buffer 127 is available to store second read data in operation S704, the emulator 120 stores the second read data in the cache memory 126 or the prefetch buffer 127 in operation S708.

For example, the emulator 120 may store second read data expected to be read in the cache memory 126 or the prefetch buffer 127 included in the emulator 120 in advance.

When the second read data expected to be read is stored in the cache memory 126 or the prefetch buffer 127 as described above, the wait time of the second memory controller 210 for receiving the second read data may be reduced by the emulator 120.

When it is determined that the cache memory 126 or the prefetch buffer 127 is not available to store the second read in operation S704, the emulator 120 generates and transmits a wait signal WAIT to the second memory controller 210 in operation S706. The emulator 120 may continuously generate and transmit the wait signal WAIT to the second memory controller 210 until the cache memory or the prefetch buffer 127 is available to store the second read data.

When the cache memory 126 or the prefetch buffer 127 become available to store the second read data, the emulator 120 stops generating the wait signal WAIT and the second read data is stored in the cache memory 126 or the prefetch buffer 127 in operation S708.

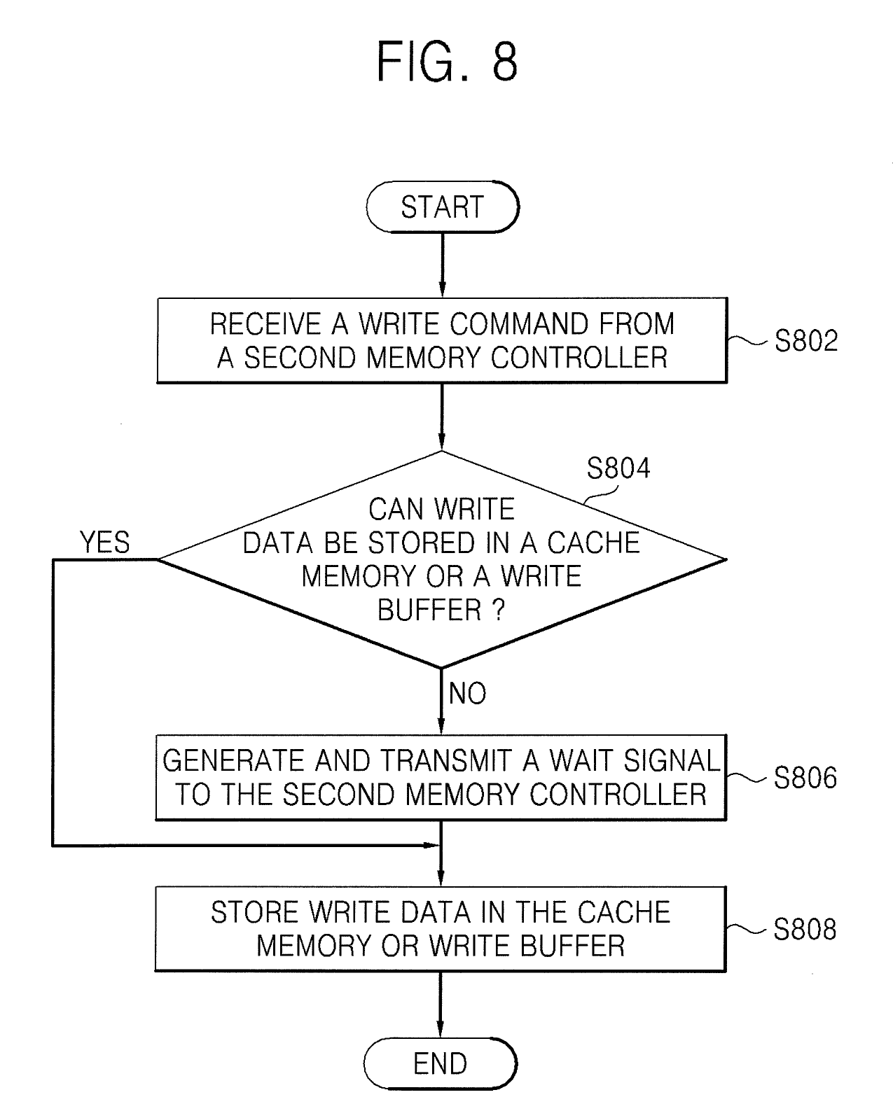

FIG. 8 is a flowchart showing a method of writing data in the memory system 1 illustrated in FIG. 1, according to an exemplary embodiment of the present invention. In the example described below with reference to FIGS. 1 through 2D and FIG. 8, the emulator 120 of the first processor 100 receives a second write command from the second memory controller 210 of the second processor 200 in operation S802. Upon receiving the second write command, the emulator controller 121 determines whether the cache memory 126 or the prefetch buffer 127 is available to store second write data corresponding to the second write command in operation S804.

When it is determined that the cache memory 126 or the write buffer 129 is available to store the second write data in operation S804, the emulator controller 121 stores the second write data in the cache memory 126 or the write buffer 129 in operation S808.

The emulator 120 may secure a space for storing the second write data corresponding to the second write command in the cache memory 126 or the write buffer 129 in advance. When the second write data is stored in the cache memory 126 or the write buffer 129 as described above, the wait time of the first memory controller 110 for writing the second write data may be reduced by the emulator 120.

When it is determined that the cache memory 126 or the write buffer 129 is not available to store the second write data in operation S804, the emulator 120 generates and transmits a wait signal WAIT to the second memory controller 210 in operation S806. When the cache memory 126 or the write buffer 129 becomes available to store the second write data, the emulator 120 stops generating the wait signal WAIT and the second write data is stored in the cache memory 126 or the write buffer 129 in operation S808.

As described above, according to exemplary embodiments of the present invention, when one of a plurality of processors is performing an operation in response to an access command, a wait signal is transmitted to the other processors and variable access latency of the processor may be managed.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A processor, comprising:
an emulator configured to receive an access command from a second memory controller; and
a first memory controller configured to control an operation of a memory,
wherein the emulator is configured to determine whether the first memory controller is available to perform an operation corresponding to the access command, and transmit a wait signal to the second memory controller upon determining that the first memory controller is not available to perform the operation.

2. The processor of claim 1, wherein the emulator comprises:
a memory interface operatively coupled to the second memory controller and configured to receive the access command; and
an emulator controller configured to transmit the wait signal to the second memory controller via the memory interface.

3. The processor of claim 1, wherein the emulator comprises:
a cache memory configured to store read data received from the memory and write data to be written to the memory; and
a cache controller configured to control an operation of the cache memory.

4. The processor of claim 1, wherein the emulator comprises a prefetch buffer configured to store read data received from the memory.

5. The processor of claim 1, wherein the emulator comprises a write buffer configured to store write data to be written to the memory.

6. The processor of claim 1, wherein the access command comprises priority information, and the emulator is configured to analyze the priority information and perform the operation corresponding to the access command based on an analysis result.

7. The processor of claim 6, wherein the priority information comprises a chip selection signal.

8. The processor of claim 6, wherein the priority information comprises an address signal.

9. The processor of claim 1, further comprising:
a plurality of intellectual property (IP) blocks; and
an interconnector operatively coupling the emulator, the first memory controller, and the plurality of IP blocks.

10. A memory system, comprising:
a memory; and
a second processor comprising a second memory controller configured to access the memory via a first processor,
wherein the first processor comprises:
an emulator configured to receive an access command from the second memory controller, and
a first memory controller configured to control an operation of the memory,
wherein the emulator is configured to determine whether the first memory controller is available to perform an operation corresponding to the access command, and transmit a wait signal to the second memory controller upon determining that the first memory controller is not available to perform the operation.

11. The memory system of claim 10, wherein the emulator comprises:
a memory interface operatively coupled to the second memory controller and configured to receive the access command; and
an emulator controller configured to transmit the wait signal to the second memory controller via the memory interface.

12. The memory system of claim 10, wherein the emulator comprises:
a cache memory configured to store read data received from the memory or write data to be written to the memory; and
a cache controller configured to control an operation of the cache memory.

13. The memory system of claim 10, wherein the emulator comprises a prefetch buffer configured to store read data received from the memory.

14. The memory system of claim 10, wherein the emulator comprises a write buffer configured to store write data to be written to the memory.

15. The memory system of claim 10, wherein the second processor comprises a plurality of intellectual property (IP) blocks and an interconnector, and the IP blocks are operatively coupled to the second memory controller through the interconnector.

16. A data processing method, comprising:
receiving an access command from a second memory controller disposed in a second processor;
determining whether a first memory controller in a first processor is available to perform an operation corresponding to the access command;
generating a wait signal upon determining that the first memory controller is not available to perform the operation;
transmitting the wait signal to the second memory controller; and
performing the operation upon determining that the first memory controller is available to perform the operation.

17. The data processing method of claim 16, wherein the operation is a read operation or a write operation.

18. The data processing method of claim 16, wherein the operation is performed on a memory operatively coupled to the first processor.

19. The data processing method of claim 16, further comprising:
generating a data strobe signal upon determining that the first memory controller is available to perform the operation;
reading data from a memory in response to the data strobe signal when the operation is a read operation; and
writing data to the memory in response to the data strobe signal when the operation is a write operation.

20. The data processing method of claim 16, further comprising:
storing data in a cache memory or a prefetch buffer disposed in the first processor, wherein the data corresponds to the access command and the data is stored before a request for the data is made by the second memory controller.
